(19) United States
(12) Patent Application Publication
(10) Pub. No.: US 2008/0190905 A1
(43) Pub. Date: Aug. 14, 2008

(54) Device For Producing a Three-Dimensional Object

(75) Inventor: Oliver Heinlein, Germering (DE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: EOS GMBH ELECTRO OPTICAL SYSTEMS, Krailling (DE)

(21) Appl. No.: 11/993,950

(22) PCT Filed: May 16, 2006
(86) PCT No.: PCT/EP06/04614

§ 371 Date: Dec. 26, 2007

(30) Foreign Application Priority Data
Jul. 1, 2005 (DE) 10 2005 030 854.6

(51) Int. Cl. B23K 26/00

(52) U.S. Cl. 219/121.73

(57) ABSTRACT

In a device for manufacturing a three-dimensional object by subsequently solidifying a solidifiable material (9) layerwise at the positions corresponding to the cross-section of the object an inner container (201) is inserted in a building container (112) that is present in a building space (3), which inner container can be exchanged. Thereby costs can be saved, because the inner container (201) can have a very simple design.

The invention is related to a device for manufacturing a three-dimensional object, in particular a device that comprises a building container, which can be removed from the device immediately after the completion of the object.

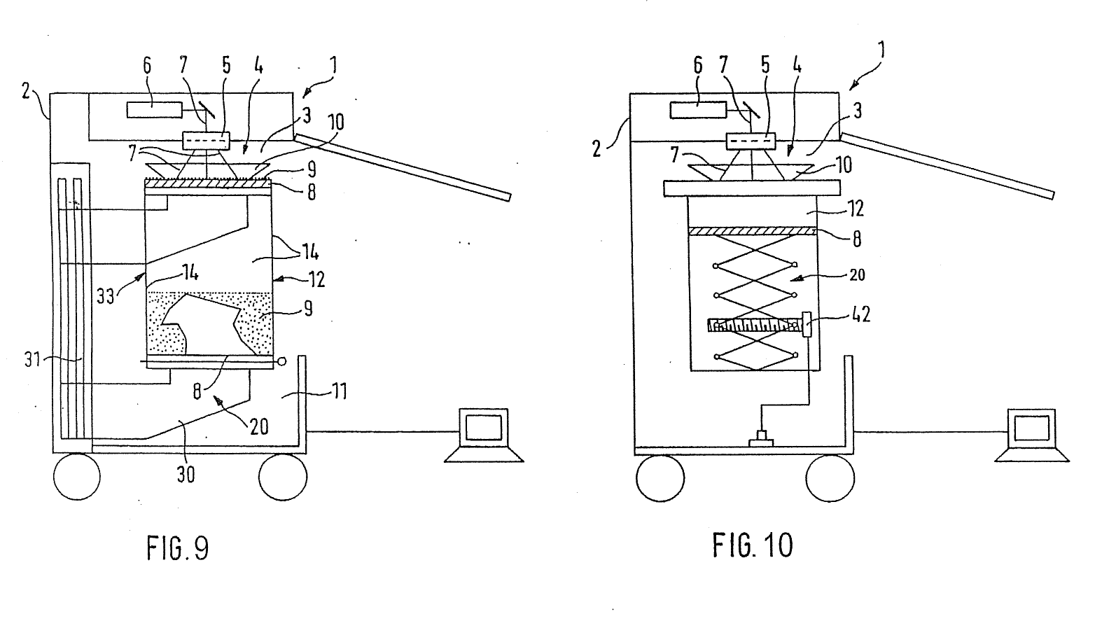

FIG. 9 shows a laser sintering machine 1 having a machine housing 2 that accommodates a building space 3, which laser sintering machine is described in the European Patent EP 1 037 739 B1. A scanner 5 of a sintering laser 6 is arranged in the upper region 4 of the building space 3 in order to deflect a laser beam 7 and to focus it onto a workpiece platform 8 or sintering material 9 that has been layered on it, wherein the sintering material 9 has been applied in layers onto the workpiece platform 8 by means of an application device 10. The sintering material 9 is supplied to the application device 10 from a supply container that is not shown.

In the lower region 11 of the building space 3 a swap container 12 has been inserted, which consists of sidewalls 14 and the workpiece platform 8 that can be moved up and down inside of the sidewalls 14, i.e. inside of the well formed by them.

In order to allow a movement of the workpiece platform 8 in height, a support device 20 is provided, which supports the workpiece platform 8 when the laser sintering machine is operated and on which the workpiece platform 8 is attached.

In FIG. 9 the workpiece platform 8 is in the uppermost position inside of the swap container 12. During the building process the workpiece platform 8 is lowered a little before a layer application so that it more and more approaches the lower end of the sidewalls 14, when the building process proceeds. After completion of the building process the workpiece platform 8 in its lower-most position is engaged with the sidewalls 14. In this condition the swap container can be removed from the building space 3 together with the workpiece platform 8 that forms its container bottom and together with the completed part.

The support device 20 consists of support arms 30 that are arranged in a guiding device 31 in the region of the backside of the machine housing. When the workpiece platform 8 is located in an upper position or a medium position of the swap container 12, the support arms 30 reach through vertical engagement openings 33 that are arranged in the sidewall at the back.

Alternatively it is also possible to fixedly install the support device 20 in the lower region of the swap container 12 as in FIG. 10 and to design it for example as scissors-type lift that can be continuously lifted and lowered by means of a spindle drive 42. Also a telescoped linear guiding for lifting and lowering the support device is possible.

Among other things the advantage of a swap container is that after the completion of a part, the part need not remain in the machine, but can be removed together with the swap container for the cooling-down process, so that the sintering machine is in a very short time available again for a new operation after the completion of the building process. However, this is only the case when several swap containers are available, so that in the machine the removed swap container can be replaced by another swap container.

A swap container can have a complex design, because in its walls a heating device may be integrated. Compared to a heating of the whole building space such a heating device has the advantage that it can react faster and involves a smaller energy input. Also, it can be adapted better to the thermal requirements of the respective building process as it would be the case when the whole lower region of the device is heated.

However, the more complex the design of a swap container the higher are the additional costs that result from the use of several of such swap containers.

The object of the present invention is therefore to provide a simply designed swap container, which nevertheless has the advantages of a heating of the powder bed close to the workpiece.

The object is achieved by a device according to claim 1. Further developments of the invention are characterized in the dependent claims.

Further features and utilities of the invention will be described based on embodiments by referring to the figures, of which show:

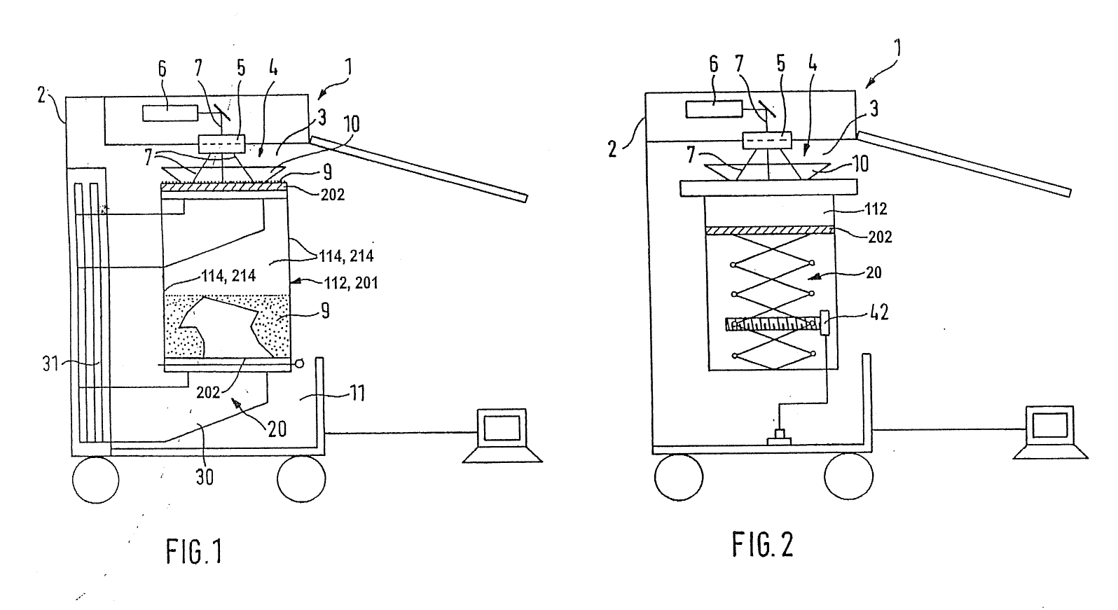

FIG. 1 a schematic sectional side view of a laser sintering machine according to the invention having a swap container,

FIG. 2 a schematic sectional side view of a laser sintering machine according to the invention having a modified support device,

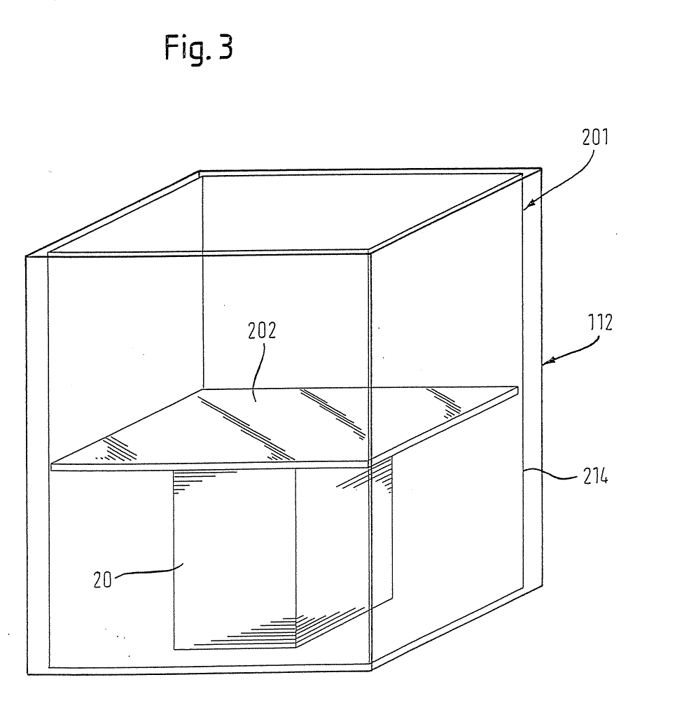

FIG. 3 a perspective view of a swap container according to an embodiment of the invention,

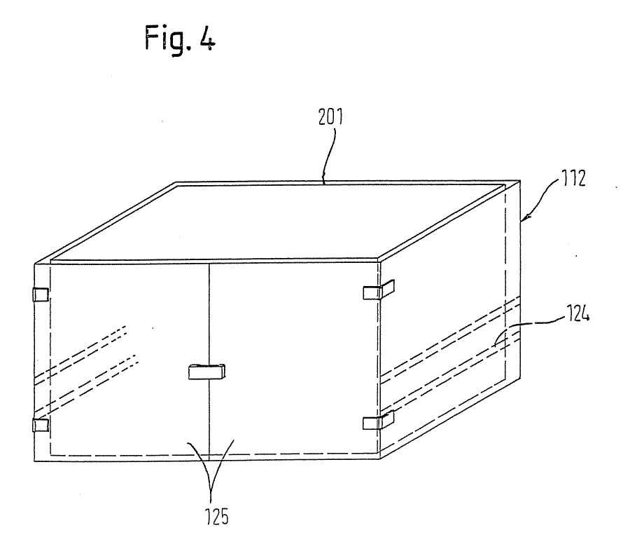

FIG. 4 a further perspective view of a swap container according to the invention,

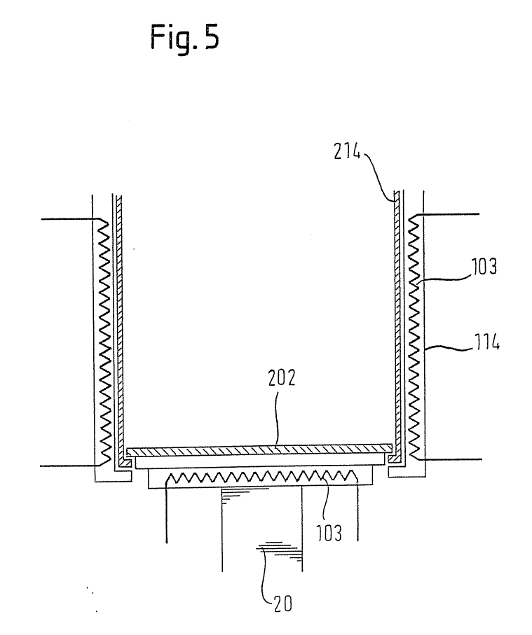

FIG. 5 a sectional view that shows the heating of a swap container according to the invention by means of a resistive heating,

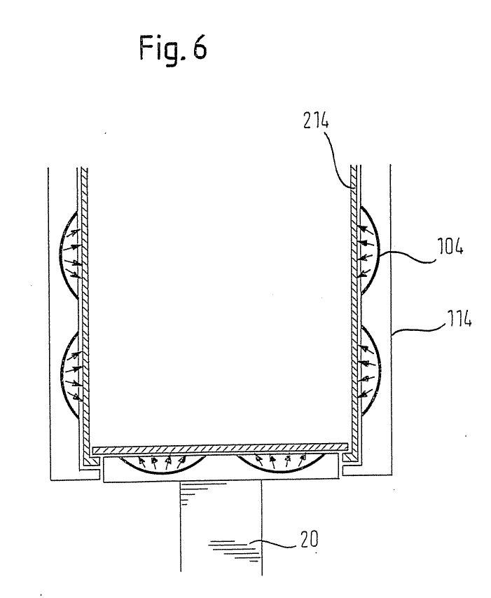

FIG. 6 a sectional view that shows the heating of a swap container according to the invention by means of a radiant heating,

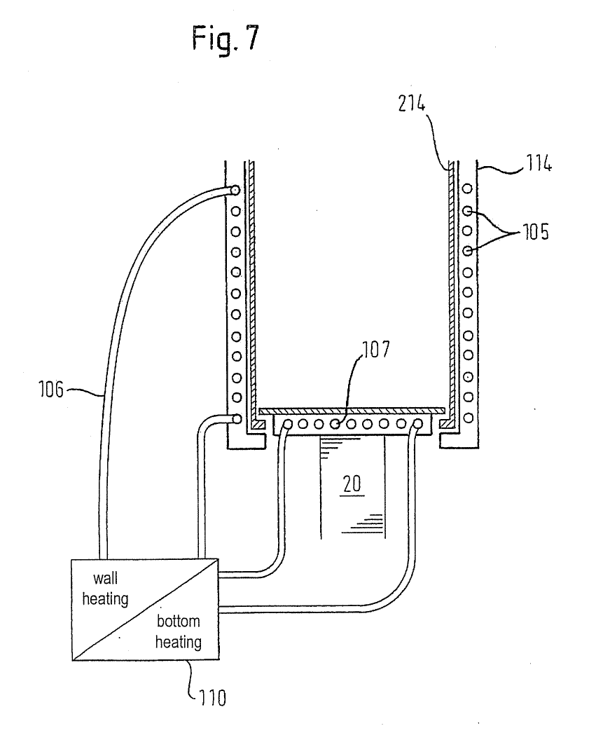

FIG. 7 a vertical cross-section that shows the heating of a swap container according to the invention by means of a fluid,

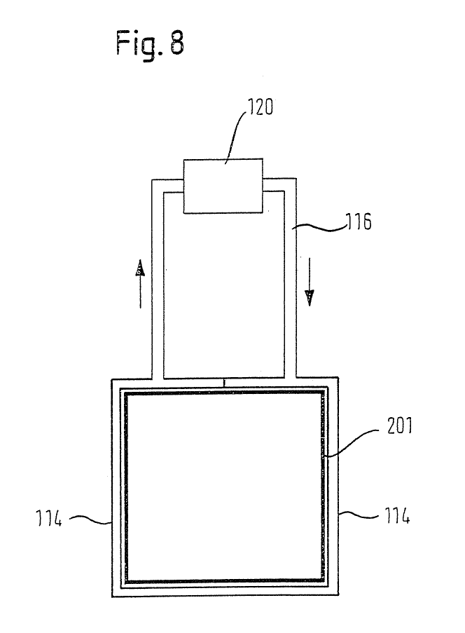

FIG. 8 a horizontal cross-section that shows the heating of a swap container according to the invention by means of a heating gas,

FIG. 9 a schematic sectional side view of a laser sintering machine having a swap container according to the prior art, and

FIG. 10 a cross-sectional view as in FIG. 9, however with a modified support device.

FIG. 3 shows a perspective view of a building container 112 that is to be used in a laser sintering machine, the sidewalls of which for reasons of explanation are shown to be transparent. In this container 112 an inner container 201 is inserted as swap container. Both containers have four sidewalls that are substantially arranged at a right angle to each other. The bottom of the inner container forms a workpiece platform 202, on which the object develops during the course of the building process. The workpiece platform 202 is supported by a support device 20 that is arranged outside of the inner container 201. Moreover, the workpiece platform 202 is sealed with respect to the sidewalls 214 of the inner container 201 by suitable sealing elements in order to avoid the loss of powder.

Though both containers 201 and 112 in FIG. 3 have a rectangular horizontal cross-section, a rectangular cross-section is not mandatory. Any cross-sectional areas, in particular also circular cross-sections, are possible.

Each of FIGS. 1 and 2 shows the arrangement of the containers 112 und 201 in a device for manufacturing three-dimensional objects according to the invention that is shown as laser sintering machine though the invention is not limited to such a device. Features that have the same reference numbers, as they were used in FIGS. 9 and 10, are identical to those features in FIG. 9 and 10. For reasons of a better illustration the building container 112 is shown to be completely transparent.

The support device 20 either can be entirely arranged below the workpiece platform 202 (FIG. 2) or it can be mounted partially lateral to the container 112 (FIG. 1).

A building process proceeds such that at first the workpiece platform 202 is moved to the upper end of the inner container 201 and then successively, i.e. layer thickness by layer thickness, the workpiece platform 202 is lowered with respect to the sidewalls 214 of the inner container 201, wherein the region above the workpiece platform is newly filled with powdery sintering material again and again. As soon as the last layer of the part has been sintered, the workpiece platform 202 can be lowered to a low region of the inner container 202 via the support device 20, where the workpiece platform 202 is locked at the sidewalls 214 of the inner container 201. This can be effected for example via plug-in sliders that are inserted into holes in the wall 214 of the inner container and in the workpiece platform 202, which holes have been aligned with each other. The inner container 201 containing the completed part can then be removed from the container 112 for a cooling-down process and a new inner container can be inserted into the container 112 for a new building process.

The exchangeable inner container 202 has a simple construction. A welded aluminium frame is sufficient, wherein the wall thickness of the aluminium frame need only be chosen to have a value that allows an easy insertion into the building container 112. Also a sufficient stability must be present for the cooling-down of the part outside of the device. Of course also other suitable materials than aluminium are conceivable.

The building container 112 can have a complex design. By the presence of heating elements in the walls 114 of the container 112 the powder bed in the inner container 201 can be effectively heated. In particular walls of the inner container 201 and the container 112 that are running in parallel and do only have a small distance from one another provide for a good heat transmission. On the one hand thereby it is not necessary to heat up the whole building space 3 in the laser sintering machine and on the other hand it is not necessary to accommodate the heating elements in the walls of the inner container to be exchanged. Though an effective heating facility is provided, nevertheless the container 201 to be exchanged can be designed in a simple and cost-effective way.

FIG. 4 shows a possibility to allow for a removeability of the inner container 201 from the container 112. To this effect the container 112 has an opening at its front side, which can be shut with doors 125. Alternatively a different closure mechanism such as a flap or a curtain is conceivable. In the case shown in FIG. 4 the removal of the inner container 201 is effected such that the latter is pulled out of the container 112 through the opening at the front side.

Besides the possibility of removal shown in FIG. 4 also other removal mechanisms for the inner container 201 are conceivable. Only as an example two further possibilities are mentioned: on the one hand the inner container can be moved out of the container 112 in a downward direction together with the workpiece platform in order to be removed then from a position below the container 112. On the other hand it is possible that the walls 114 of the container 112 are moved upward into a region above the inner container 201. Then the inner container 201 can be taken out from the front side of the device. In this case it is not necessary to provide an opening for removal of the inner container 201 in the container 112.

In order to avoid a downward movement of the inner container 201 with respect to the container 112, a plurality of embodiments is conceivable As an example in FIG. 4 protrusions 124 are attached to the inner sides of two opposing sidewalls 114 of the container 112, which protrusions serve for a fastening of the sidewalls 214 of the inner container 201 to the container 112. These protrusions can for example be designed in the shape of horizontal surfaces, which protrude to the inside of the container 112 perpendicular to the walls 114. In this case the inner container 201 can rest with its bottom side on the horizontal surfaces or else it can have outer protrusions at the outer side of its sidewalls 214, which bear on the mentioned horizontal surfaces and prevent a downward movement of the inner container 201 with respect to the building container 112.

FIG. 5 shows as an example for a heating of the inner container 201 heating resistors 103 that are fitted in the sidewalls 114 of the container 112. Further, a resistance heater 3a is shown below the workpiece platform 202. This bottom-side resistance heating 103a is moved during the building process together with the workpiece platform 202 by the support device 20. It is possible that the resistance heating is accommodated in the bottom of the container 112, which then is moved with respect to the inner side of the walls 214 of the inner container 201 together with the workpiece platform 202 by the support device 20 arranged thereunder.

In order to allow for a good heat transmission, it is advantageous that for this manner of heating the walls 114 and 214 of both containers lie closely against each other. Furthermore, the inner container 201 should be made from a material that is a good heat conductor.

FIG. 6 shows an embodiment, in which radiant heaters 104 are arranged in the sidewalls of the container 112 and below the workpiece platform 202. For this way of heating it is not troublesome if there is a gap between the walls of both containers, because the heat is passed on by radiation to the wall of the inner container, which conducts it to the powder bed.

The provision of a heating outside of the inner container 201 makes it possible to choose methods of heating that would lead to problems when used in a container to be exchanged. FIG. 7 shows as an example a heating by means of a fluid that flows in heating pipes 105 surrounding the inner container 201. The heating pipes are connected to a heating and pumping unit 110 by pipes 106, wherein the heating and pumping unit 110 heats up the fluid and pumps it through the heating pipes. Simultaneously to that the heated fluid is pumped through pipes 107 below the workpiece platform 202.

In a case, in which it was necessary to exchange the heating pipes together with the inner container 201, the coupling and uncoupling of the heating pipes from the heating and pumping unit 110 would make the exchange operation of the container 201 more complex.

It is also possible to use a heating gas instead of a fluid for the heating, as it is shown in FIG. 8. FIG. 8 shows a horizontal cross-section of an inner container 201 that is heated by means of heating gas. The heating gas circulates in the process through cavities 108 in the walls 114 of the container 112. The cavities 108 in the walls are connected to a heating device 120 via feed pipes 116. Though this is not shown in FIG. 8, the workpiece platform 202 can be heated in the same way.

In case the heating gas would flow through cavities in the walls of a container to be exchanged, a sealing would be necessary in order to avoid an escape of gas when a container is exchanged, which would lead to an increased complexity of the swap container.

As already mentioned, the invention is not limited to a laser sintering machine, but may be applied to all rapid prototyping processes, in which an object is built from a solidifiable material layer-wise on a building or workpiece platform.

1. Device for manufacturing a three-dimensional object by subsequently solidifying a solidifiable material layerwise at the positions corresponding to the cross section of the object having
a building space provided in a machine frame, in which a container is provided and
a support device,
wherein an inner container is arranged inside of the container, which inner container is a confining frame for the material having a container bottom that forms a workpiece platform, which workpiece platform during the operation of the device is supported by the support device and can be moved relative to the walls of the inner container, wherein the inner container is removable from the container.

2. Device according to claim 1, in which the container is a pre-manufactured swap container that can be removed from the building space.

3. Device according to claim 1, in which the bottom of the container is arranged between the workpiece platform and the support device, which bottom of the container can be moved relative to the walls of the inner container.

4. Device according to claim 1, in which a heating device is integrated in the container.

5-11. (canceled)

12. Device according to claim 2, in which a heating device is integrated in the container.

13. Device according to claim 3, in which a heating device is integrated in the container.

14. Device according to claim 4, in which the heating device consists of resistance heating elements that are integrated in the walls of the container.

15. Device according to claim 12, in which the heating device consists of resistance heating elements that are integrated in the walls of the container.

16. Device according to claim 4, in which the heating device consists of radiant heating elements that are integrated in the walls of the container.

17. Device according to claim 12, in which the heating device consists of radiant heating elements that are integrated in the walls of the container.

18. Device according to claim 4, wherein the heating is effected by a fluid that circulates inside of the walls and/or the bottom of the container.

19. Device according to claim 12, wherein the heating is effected by a fluid that circulates inside of the walls and/or the bottom of the container.

20. Device according to claim 4, in which the heating is effected by a gas that circulates inside of the walls and/or the bottom of the container.

21. Device according to claim 12, in which the heating is effected by a gas that circulates inside of the walls and/or the bottom of the container.

22. Device according to claim 1, in which the workpiece platform is lockable at the walls of the inner container.

23. Device according to claim 4, in which the workpiece platform is lockable at the walls of the inner container.

24. Device according to claim 1, in which the support device consists of a lifting device that is arranged in the lower part of the container.

25. Device according to claim 4, in which the support device consists of a lifting device that is arranged in the lower part of the container.

26. Device according to claim 1, in which the inner container can be shifted into the container along two guidings that are attached at the sidewalls of the container.

27. Device according to claim 4, in which the inner container can be shifted into the container along two guidings that are attached at the sidewalls of the container.
